(19) United States
(12) Patent Application Publication
(10) Pub. No.: US 2001/0049825 A1
(43) Pub. Date: Dec. 6, 2001

(54) Network device with dual machine addresses

(76) Inventors: Ryota Hirose, Hamamatsu (JP); Masayuki Chiba, Hamamatsu (JP); Masashi Hirano, Hamamatsu (JP)

Correspondence Address: Roger R. Wise, Pillsbury Winthrop LLP, Suite 1200, 725 South Figueroa Street, Los Angeles, CA, 90017-5443, US

(21) Appl. No.: 09/846,760

(22) Filed: May 1, 2001

(30) Foreign Application Priority Data
May 2, 2000 (JP) 2000-133075

(51) Int. Cl. H04N 7/173

(52) U.S. Cl. 725/111

(57) ABSTRACT

A network device is connectable to a network for use in directing data. The receiving process is executed by receiving data having a physical address indicating a destination of the data, comparing the physical address of the received data with registered physical addresses, completing the receiving process when the physical address of the received data matches with one of the registered physical addresses, and otherwise canceling the receiving process. The transmitting process is executed by detecting a destination of data to be transmitted, selecting one of the registered physical addresses according to the detected destination of the data to be transmitted, and attaching the selected physical address to the data, thereby indicating an origin of the data.

### BACKGROUND OF THE INVENTION

1. Field of the Invention

The present invention relates to a router or other network devices connected to a computer network for networking use, and a computer network containing the network devices.

2. Related Background Art

In recent years, a CATV Internet utilizing a cable television (CATV) network for an Internet access begins to be popularized. FIG. 2 shows an outline of a network configuration of the conventional CATV Internet. A center (a TV broadcasting station) 10 is connected to subscriber's premises 12 via a CATV cable 14 (a coaxial cable or an optical fiber). In the subscriber's premises 12, an end of the CATV cable 14 is connected to a CATV port (a CATV interface terminal) 18 of a cable modem 16. An Ethernet port (an Ethernet interface terminal) 20 forming a LAN port of the cable modem 16 is connected to an Ethernet port 22 of a computer PC1 via an Ethernet cable 24 such as a 10BASE-T cable. A subscriber can operate the computer PC1 so as to gain access to the Internet 26 via the cable modem 16 and the center 10.

In many cases, a CATV Internet service provider limits the number of global IP addresses (an IP address is a logical address) which can be used by each subscriber to only one as a global IP address, and causes the center 10 to dynamically allocate one global IP address (assumed to be “IP1 (G1)” (G1 indicates a global address)) to the computer PC1 of each subscriber's premises 12 by DHCP (dynamic host configuration protocol). Additionally in the CATV network, the CATV network assumes a single segment, and traffics of other subscribers can be easily viewed furtively. Accordingly in some cases, a filter is installed in the cable modem 16 by an MAC address (a physical address) (assumed to be “Ma1”) of the subscriber's computer PC1 so as to interrupt traffics not related to the subscriber at the cable modem 16 to thereby prevent messages from being transmitted to the side of the Ethernet (the local computer PC1 side). Furthermore, in a direction from the subscriber's premises 12 to the center 10, a filter is further installed by the MAC address “Ma1” of the computer PC1 to limit the number of computers which can be used by the subscriber to only one.

The CATV Internet service restricts the number of available computers to one by means of the DHCP and MAC address filter as described above. Even in such a condition that a plurality of computers PC1 (MAC address: Ma1) and PC2 (MAC address: Ma2) are involved in the local side of the Ethernet by using a hub or the like as shown in FIG. 3, a computer which can be connected to the Internet is limited to the computer PC1 to which the MAC address “Ma1” is given and to which the global IP address “IP1 (G1)” is allocated in DHCP by the center 10, and the other computer PC2 cannot be connected to the global Internet. Furthermore, no local or private IP address is allocated to the computer PC2, thus disabling communications between the computers PC1 and PC2.

### SUMMARY OF THE INVENTION

Therefore, it is a general object of the invention to enable a plurality of computers to gain access to the Internet individually, and at the same time, to enable communications between a plurality of computers when the number of available computers is limited to one by means of the DHCP and the MAC address filter. It is a specific object of the invention to provide a network device capable of using selectively and properly a plurality of physical addresses without preparing network interfaces separately for the global Internet and private LAN such as intranet.

In one aspect of the invention, a network device is connectable to a network for use in directing data. The inventive network device comprises an interface that is provided for interfacing with the network and that is allocated with a plurality of physical addresses registered for physically discriminating from other devices, and a processor that executes a receiving process and a transmitting process of data through the interface. The receiving process comprises the steps of receiving data having a physical address indicating a destination of the data, comparing the physical address of the received data with the registered physical addresses, completing the receiving process when the physical address of the received data matches with one of the registered physical addresses, and otherwise canceling the receiving process when the physical address of the received data matches with none of the registered physical addresses. The transmitting process comprises the steps of detecting a destination of data to be transmitted, selecting one of the registered physical addresses according to the detected destination of the data to be transmitted, and attaching the selected physical address to the data, thereby indicating an origin of the data.

Preferably, the interface is allocated with a first physical address for use in an Internet domain, and a second physical address for use in a local area network domain. The processor executes the transmitting process such that the selecting step selects the first physical address when the destination of the data to be transmitted is given as a global IP address, and otherwise selects the second physical address when the destination of the data to be transmitted is given as a private IP address.

For example, the inventive network device functions as a DHCP client in the Internet domain so that the DHCP client is allocated a global IP address from another DHCP server of the Internet domain, and also functions as a DHCP server in the local area network domain so that the DHCP server allocates a private IP address to another DHCP client in the local area network domain. The processor uses the first physical address for exchanging data with said another DHCP server of the Internet domain, and uses the second physical address for exchanging data with said another DHCP client of the local area network domain.

In another aspect of the invention, a network device comprises a port connectable to a network, a storage section that stores a plurality of physical addresses registered for physically discriminating from other network devices, a receiver section that executes a receiving process of data inputted from the network through the port, a transmitter section that executes a transmitting process of data outputted to the network through the port, and a controller section that controls the receiver section and the transmitter section. In the inventive network device, the receiver section operates when receiving data containing a destination physical address indicating a destination of the data for comparing the destination physical address with the stored physical addresses, thereby completing the receiving process when the destination physical address matches with one of the stored physical addresses, and otherwise canceling the receiving process when the destination physical address matches with none of the stored physical addresses. The transmitter section operates when transmitting data to a desired destination for attaching one of the stored physical addresses, which indicates an origin of the dada and which is designated by the controller section dependently on the desired destination of the dada to be transmitted.

Preferably, the storage section stores a first physical address for use in an Internet domain, and a second physical address for use in a local area network domain, The controller section designates the first physical address when the destination of the data to be transmitted is given as a global IP address, and otherwise designates the second physical address when the destination of the data to be transmitted is given as a private IP address.

Practically, the inventive network device functions as a DHCP client in the Internet domain so that the DHCP client is allocated a global IP address from another DHCP server of the Internet domain, and also functions as a DHCP server in the local area network domain so that the DHCP server allocates a private IP address to another DHCP client in the local area network domain. In such a case, the controller section designates the first physical address for transmitting data to said another DHCP server of the Internet domain, and designates the second physical address for transmitting data to said another DHCP client of the local area network domain.

In a further aspect of the invention, a network device is provided for use in directing data and being connectable to a cable modem having a CATV port and a LAN port. The inventive network device comprises a network interface that is connected to the LAN port of the cable modem, and that is allocated with a first physical address selectively used for communication with an outside network interface linked to the CATV port of the cable modem and a second physical address selectively used for communication with an inside network interface linked to the LAN port of the cable modem, and a processor that executes a receiving process and a transmitting process of data through the network interface. The receiving process comprises the steps of receiving data having a destination physical address indicating a destination of the data, detecting when the destination physical address of the received data matches with the first physical address for admitting and treating the received data as being transmitted from an outside network interface linked to the CATV port of the cable modem, detecting when the destination physical address of the received data matches with the second physical address for admitting and treating the received data as being transmitted from an inside network interface linked to the LAN port of the cable modem, and detecting when the destination physical address of the received data matches with neither of the first physical address and the second physical address for discarding the received data. The transmitting process comprises the steps of detecting when a destination of data to be transmitted is an outside network interface linked to the CATV port of the cable modem for selecting and attaching the first physical address to the data as an origination physical address indicating an origin of the data, and detecting when a destination of data to be transmitted is an inside network interface linked to the LAN port of the cable modem for selecting and attaching the second physical address to the data as an origination physical address indicating an origin of the data.

Preferably, the processor executes the receiving process and the transmitting process by the steps of receiving data from an inside network interface linked to the LAN port of the cable modem, the data containing a logical address indicating an ultimate destination of the data, detecting when the logical address indicates the ultimate destination other than inside network interfaces for rewriting a destination physical address contained in the data to another destination physical address allocated to a predetermined outside network interface and for rewriting an origination physical address contained in the data to the first physical address, and transmitting the data containing the logical address and the rewritten destination physical address and the rewritten origination physical address. Further, processor executes the receiving process and the transmitting process by the steps of receiving data from an outside network interface linked to the CATV port of the cable modem, the data containing a logical address indicating an ultimate destination of the data, detecting when the logical address is allocated to an inside network interface for rewriting a destination physical address contained in the data to another destination physical address allocated to the inside network interface corresponding to the logical address and for rewriting an origination physical address contained in the data to the second physical address, and transmitting the data containing the logical address and the rewritten destination physical address and the rewritten origination physical address.

Preferably, the processor executes the transmitting process such that the detecting step detects when the logical address contained in the data represents a global IP address for rewriting a destination physical address to another destination physical address allocated to a CATV center and for rewriting an origination physical address contained in the data to the first physical address, and otherwise detects when the logical address represents a private IP address allocated to an inside network interface for rewriting a destination physical address contained in the data to another destination physical address allocated to the inside network interface corresponding to the private IP address and for rewriting an origination physical address contained in the data to the second physical address.

Practically, the network device functions as a DHCP client in an Internet domain so that the DHCP client is allocated a global IP address from another DHCP server of the CATV center, and also functions as a DHCP server in a local area network domain so that the DHCP server allocates a private IP address to an inside network interface linked to the LAN port of the cable modem. Then, the processor uses the first physical address for exchanging data with the CATV center, and uses the second physical address for exchanging data with the inside network interface.

### BRIEF DESCRIPTION OF THE DRAWINGS

FIG. 1 is a system configuration diagram showing an embodiment of a computer network according to the present invention;

FIG. 2 is a system configuration diagram showing an outline of a network configuration of a conventional CATV Internet;

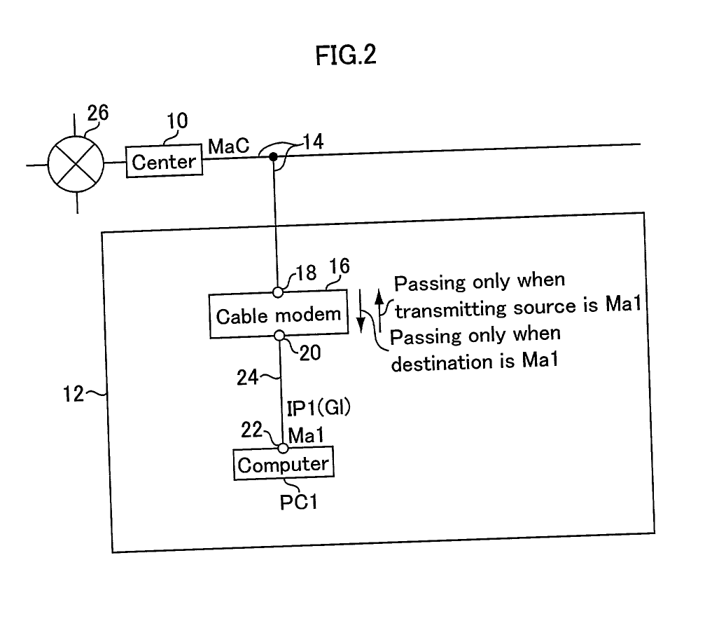

FIG. 3 is a diagram showing an arrangement in which a plurality of computers are further connected to a LAN port of a cable modem in the configuration shown in FIG. 2;

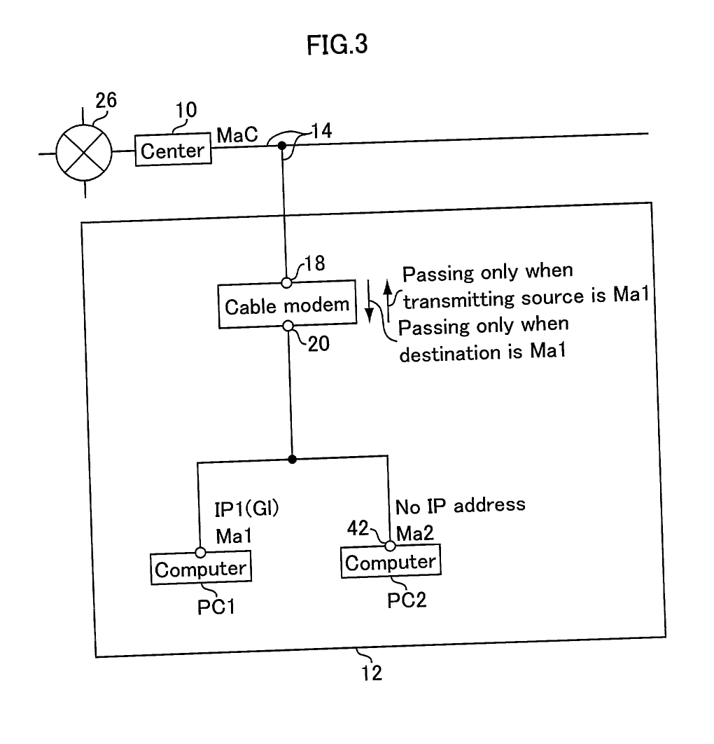

FIG. 4 is a system configuration diagram showing a basic network configuration used for enabling an Internet access from a plurality of computers individually and for enabling communications among the plurality of computers through LAN;

FIG. 5 is a system configuration diagram showing a concrete example of a hardware configuration inside subscriber's premises shown in FIG. 1;

FIG. 6 is a block diagram showing an outline of an example of a hardware configuration in a router shown in FIG. 1 and FIG. 5;

FIG. 7 is a diagram showing an example of a control flow with a CPU at receiving data shown in FIG. 6; and

FIG. 8 is a diagram showing an example of a control flow with a CPU at transmitting data shown in FIG. 6.

### DETAILED DESCRIPTION OF THE PREFERRED EMBODIMENTS

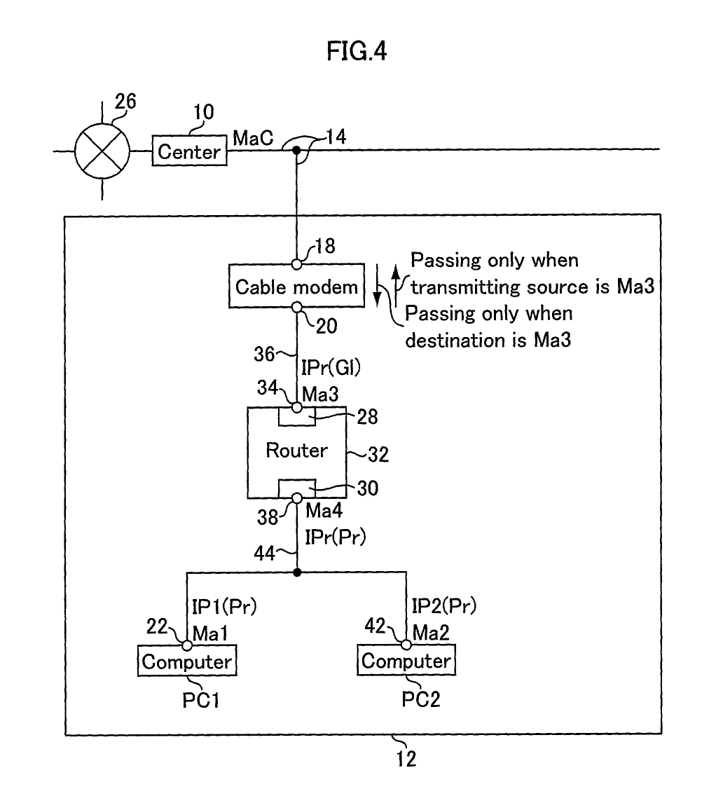

A basic device will be described in FIG. 4 for better understanding of the invention. In this configuration, a plurality of computers PC1 and PC2 are connected to a cable modem 16 via a router 32 including two Ethernet interfaces 28 (MAC address: Ma3) and 30 (MAC address: Ma4). The router 32 is treated as a DHCP client and a global IP address (assumed to be “IPr (G1)”) is allocated to the Ethernet interface 28 by a DHCP server of the center 10. In addition, a private IP address (“IPr (Pr)” (“Pr” indicates a private address)) is preset to the router 32. Furthermore, the router 32 also operates as a DHCP server to allocate private IP addresses (assumed to be “IP1 (Pr) and “IP2 (Pr),” respectively) to the computers PC1 and PC2. An Ethernet port 20 of the cable modem 16 is connected to a first Ethernet port 34 of the router 32 via an Ethernet cable 36 such as a 10BASE-T cable. A second Ethernet port 38 of the router 32 is connected to Ethernet ports 22 and 42 of the computers PC1 and PC2 by using an Ethernet cable 44 such as a 10BASE-T cable via a hub or the like.

“Ma3” is set in the cable modem 16 for the MAC address filter, the MAC address is converted from “Ma3” to “Ma4” and from “Ma4” to “Ma3” in the router 32, the IP address is converted from the global IP address “IPr (G1)” to the private IP address “IPr (Pr)” and from the private IP address “IPr (Pr)” to the global address “IPr (G1),” by which the computers PC1 and PC2 can gain access to the Internet 26 individually (massages directed to the computers PC1 and PC2 are well discriminatively distributed by using port numbers to these computers). In addition, the private IP addresses “IP1 (Pr)” and “IP2 (Pr)” are allocated to the computers PC1 and PC2, respectively, and therefore the computers PC1 and PC2 can communicate with each other through the local area network (LAN).

As set forth in the above, according to the network configuration shown in FIG. 4, a plurality of computers PC1 and PC2 can gain access to the Internet 26 individually even if the number of available computers is limited to one by means of the DHCP and the MAC address filter. In addition, the plurality of computers PC1 and PC2 can communicate with each other through LAN. The router 32, however, has a drawback of requiring two expensive Ethernet interfaces 28 and 30 (in other words, the router should include two LSI or other circuit elements each forming an Ethernet interface). In view of this drawback, the following inventive embodiment is devised. The goal of the following inventive embodiment is to provide a network device capable of using properly a plurality of physical addresses without preparing network interfaces individually and to provide a computer network system containing such a network device.

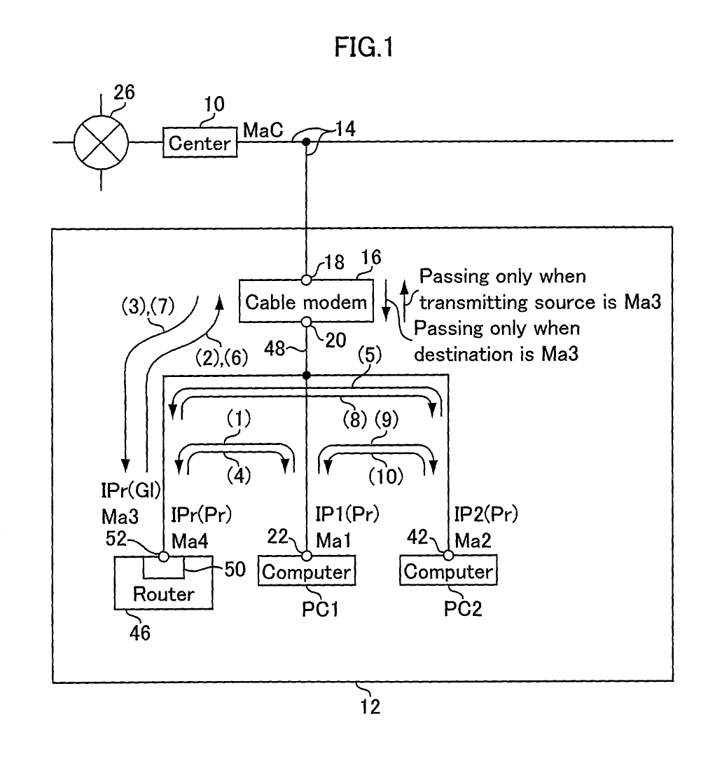

Now, the embodiment of this invention will be described below. Referring to FIG. 1, there is shown a diagram of an embodiment of a computer network according to the present invention. The same elements as for FIG. 4 are designated by identical reference numerals. A center 10 is connected to subscriber's premises 12 via a CATV cable 14. In the subscriber's premises 12, an end of the CATV cable 14 is connected to a CATV port 18 of a cable modem 16. Computers PC1 and PC2 contain Ethernet interfaces (not shown), respectively, and a router 46 contains a single Ethernet interface 50. An Ethernet port 20 forming a LAN port of the cable modem 16 is connected to Ethernet ports 22 and 42 of the computers PC1 and PC2 and an Ethernet port 52 of the router 46 (to which this invention is applied) via a hub or the like through Ethernet cables 48 such as 10BASE-T cables or the like.

The Ethernet interface 50 has at least two registered MAC addresses (unicast MAC addresses, namely, MAC addresses specific to the device not used for other devices) “Ma3” and “Ma4”. The one MAC address “Ma3” is used for a global communication with a network interface (namely, a network interface to which a global IP address is allocated) arranged in the side of the CATV port 18 of the cable modem 16. The other MAC address “Ma4” is used for a local communication with the respective network interfaces (namely, network interfaces to which private IP addresses are allocated) of the computers PC1 and PC2 arranged in the side of the Ethernet port 20 of the cable modem 16. The router 46 is treated as a DHCP client and a global IP address “IPr (G1)” is allocated to its Ethernet interface 50 by a DHCP server of the center 10. In addition, a private IP address “IPr (Pr)” is preset to the router 46. Furthermore, the router 46 functions as a DHCP server to allocate private IP addresses “IP1 (Pr) and “IP2 (Pr)” to the computers PC1 and PC2, respectively.

An MAC address filter of the cable modem 16 is set to “Ma3” and a signal from an outside to an inside of the subscriber's premises 12 can be received through the cable modem 16 and accepted only when the Ethernet frame of the signal has the destination MAC address “Ma3.” A signal from the inside to the outside of the subscriber's premises 12 can be transmitted through the cable modem 16 only then the Ethernet frame of the signal has the transmitting source MAC address “Ma3.”

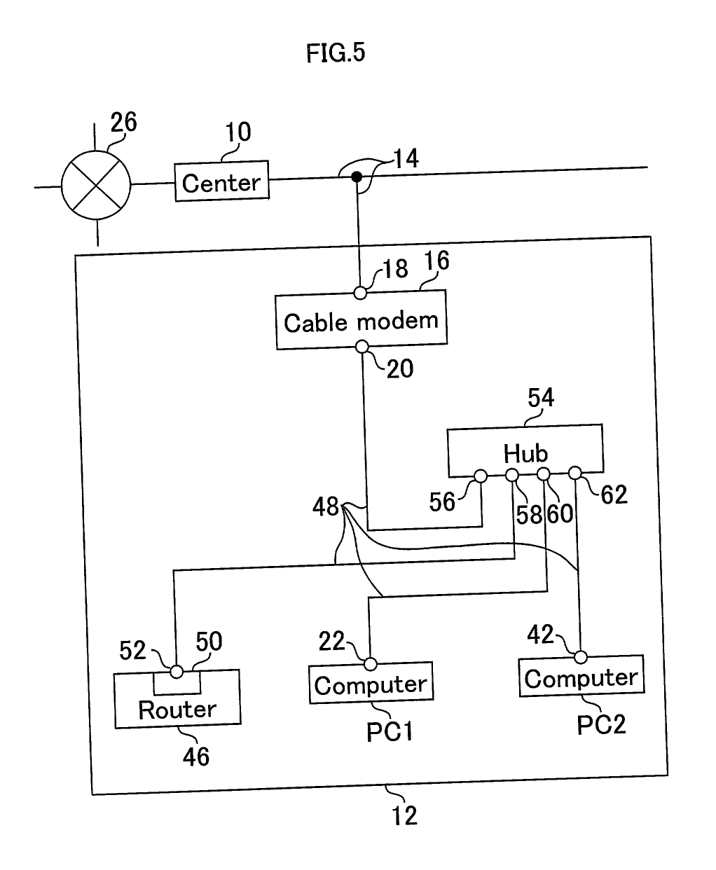

Referring to FIG. 5, there is shown a concrete example of a hardware configuration in the subscriber's premises 12 shown in FIG. 1. It is based on a configuration in the 10BASE-T Ethernet interface specifications for a network formed in the side of the Ethernet port 20 of the cable modem 16. Respective Ethernet ports (10BASE-T ports) 20, 52, 22, and 42 of the cable modem 16, the router 46, the computers PC1 and PC2 are connected to ports (10BASE-T ports) 56, 58, 60, and 62 of a hub 54 through the 10BASE-T cable 48, respectively. Ethernet interfaces other than the 10BASE-T can be used for the above.

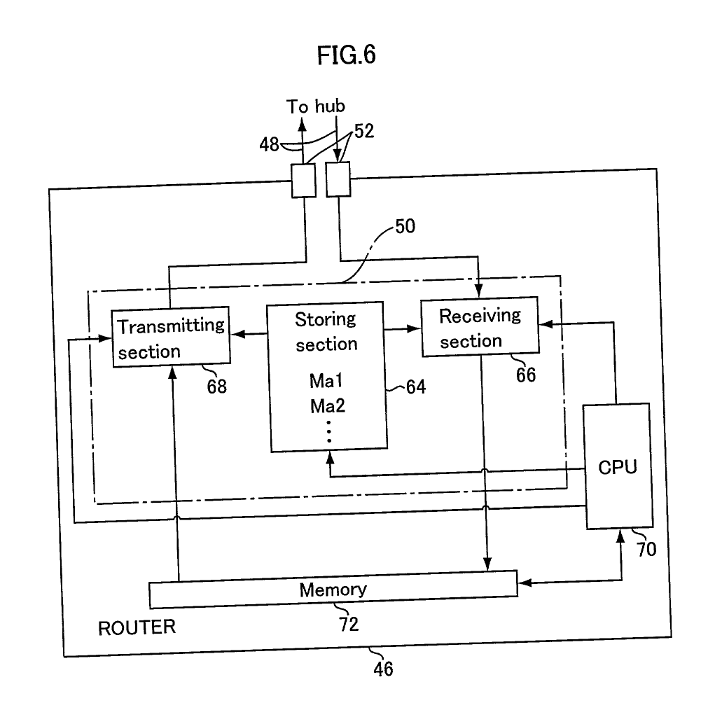

Referring to FIG. 6, there is shown an outline of an example of a hardware configuration inside the router 46. The Ethernet interface 50 includes a storing section 64, a receiving section 66, and a transmitting section 68. The storing section 64 comprises a ROM, a flash ROM or the like and stores a plurality of MAC addresses “Ma3,” “Ma4,” and after. The receiving section 66 receives and processes an Ethernet frame received by the Ethernet port 52. The transmitting section 68 transmits and processes an Ethernet frame created by the router 46. A CPU 70 retains the Ethernet frame received by the receiving section 66 in a memory (RAM) 72 temporarily, and then compares a destination MAC address included in the received Ethernet frame with the MAC addresses “Ma3,” “Ma4,” . . . stored in the storing section 64; if there is matching among MAC addresses, it is determined that incoming data should be sent to the target computer and the receiving processing is continued. Otherwise, the received Ethernet frame is discarded (deleted from the memory 72) if there is no matching among the MAC addresses.

The CPU 70 creates an Ethernet frame to be transmitted. This transmission Ethernet frame is given “Ma3” as a transmitting source MAC address, if the destination of the Ethernet frame is outside the subscriber's premises 12 (namely, if the destination IP address is a global IP address), or otherwise given “Ma4” if the destination is inside the subscriber's premises 12 (namely, if the destination IP address is a private IP address). The CPU 70 retains the created transmission Ethernet frame in the memory 72 temporarily, and then transmits it from the transmitting section 68.

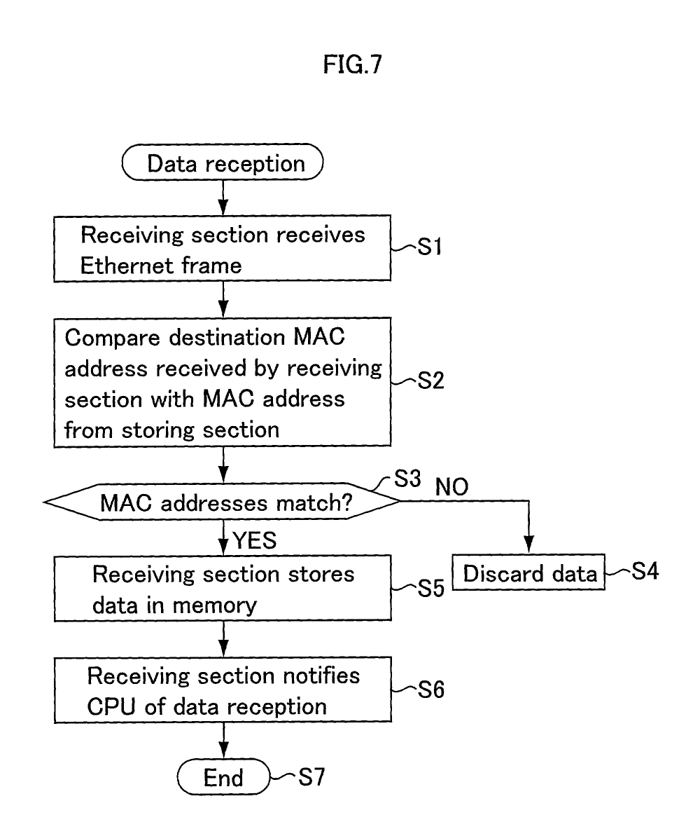

Referring to FIG. 7, there is shown an example of a control flow with the CPU 70 at receiving of data. When the receiving section 66 receives an Ethernet frame (S1), the receiving section 66 compares a destination MAC address included in the received data with MAC addresses registered in the storing section 64 (S2); if there is no matching, the data is discarded (S3, S4), while otherwise the data is stored in the memory 72 (S5). After the data is stored, the receiving section 66 notifies the CPU 70 of the data receiving (S6) and terminates the reception of the data (S7).

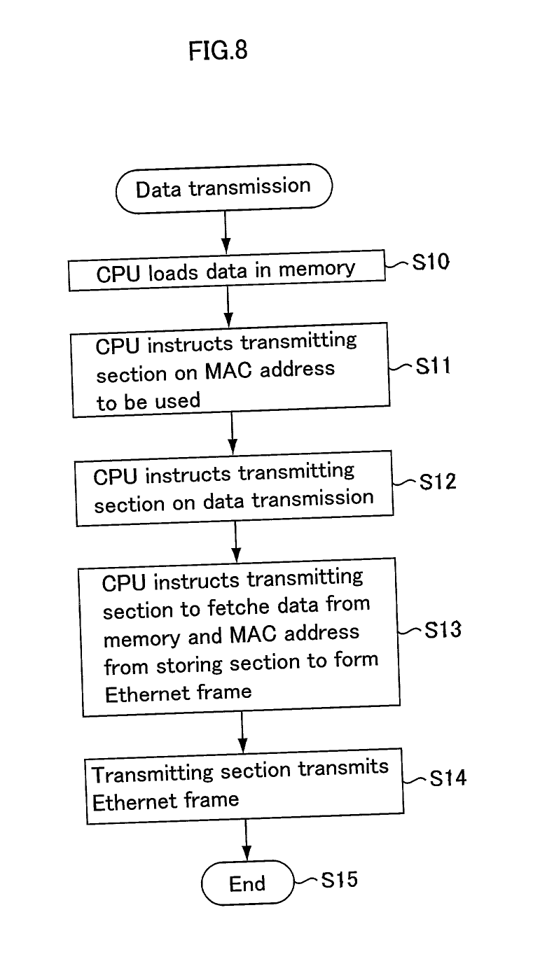

Referring to FIG. 8, there is shown an example of a control flow with the CPU 70 performed at transmitting of data. When data is transmitted, the CPU 70 loads and expands the body of the data to be transmitted to the memory 72 (S10). The CPU 70 instructs the transmitting section 68 on an MAC address used as a transmitting source address among the MAC addresses stored in the storing section 64 according to the destination (S11) and the CPU 70 instructs the transmitting section 68 on data transmission (S12). In response to the instructions, the transmitting section 68 fetches the body of the data from the memory 72 and the MAC address used as the destination address from the storing section 64, and then forms an Ethernet frame (S13). The transmitting section 68 transmits the Ethernet frame (S14) and terminates the data transmission process (S15).

Referring back to FIG. 6, the storing section 64 may receive a machine readable medium such as ROM for use in the network device having a port connectable to a network, a storage (64) that stores a plurality of physical addresses registered for physically discriminating from other network devices, a receiver (66) that performs a receiving process of data inputted from the network through the port, a transmitter (68) that performs a transmitting process of data outputted to the network through the port, and a processor (70) that controls the receiver and the transmitter. The medium may contain program instructions executable by the processor or CPU 70 to perform a method comprising the steps of controlling the receiver when receiving data containing a destination physical address indicating a destination of the data for comparing the destination physical address with the stored physical addresses, thereby completing the receiving process when the destination physical address matches with one of the stored physical addresses, and otherwise canceling the receiving process when the destination physical address matches with none of the stored physical addresses, and controlling the transmitter when transmitting data to a desired destination for attaching one of the stored physical addresses, which indicates an origin of the dada and which is designated by the processor dependently on the desired destination of the dada to be transmitted.

Next, an example of a communication flow with a computer network having the above configuration will be described below. For a communication from the computer PC1 to a computer outside the subscriber's premises 12 (a global IP address assumed to be “IPn (G1)”), address information listed in Table 1 is appended to the Ethernet frame in the following processes shown in FIG. 1 as (1) to (4). In this condition, a MAC address of the center 10 is assumed to be “MaC.”

(1) Transmitted from the computer PC1 to the router 46

(2) Transmitted from the router 46 to the center 10

(3) Transmitted from the center 10 to the router 46

(4) Transmitted from the router 46 to the computer PC1

TABLE 1

| | Destination | Originating | Destination | Originating |
|---|---|---|---|---|
| Process | MAC | MAC | IP | IP |
| (1) | Ma4 | Ma1 | IPn (Gl) | IP1 (Pr) |
| (2) | MaC | Ma3 | IPn (Gl) | IPr (Gl) |
| (3) | Ma3 | MaC | IPr (Gl) | IPn (Gl) |
| (4) | Ma1 | Ma4 | IP1 (Pr) | IPn (Gl) |

In the process (4), it is determined that the destination is the computer PC1 on the basis of a destination port number appended to the Ethernet frame in the process (3) and then the destination MAC address “Ma1” and the destination IP address “IP1 (Pr)” are given before transmission.

For a communication from the computer PC2 to a computer outside the subscriber's premises 12 (a global IP address “IPn (G1)”, address information listed in Table 2 is appended to the Ethernet frame in the following processes shown in FIG. 1 as (5) to (8).

(5) Transmitted from the computer PC2 to the router 46

(6) Transmitted from the router 46 to the center 10

(7) Transmitted from the center 10 to the router 46

(8) Transmitted from the router 46 to the computer PC2

TABLE 2

| | Destination | Originating | Destination | Originating |
|---|---|---|---|---|
| Process | MAC | MAC | IP | IP |
| (5) | Ma4 | Ma2 | IPn (Gl) | IP2 (Pr) |
| (6) | MaC | Ma3 | IPn (Gl) | IPr (Gl) |
| (7) | Ma3 | MaC | IPr (Gl) | IPn (Gl) |
| (8) | Ma2 | Ma4 | IP2 (Pr) | IPn (Gl) |

In the process (8), it is determined that the destination is the computer PC2 on the basis of a destination port number appended to the Ethernet frame in the process (7), and then the destination MAC address “Ma2” and the destination IP address “IP2 (Pr)” are given before transmission.

For communications between the computers PC1 and PC2 inside the subscriber's premises 12, address information listed in Table 3 is appended to the Ethernet frame in the following processes shown in FIG. 1 as (9) to (10).

(9) Transmitted from the computer PC1 to the computer PC2

(10) Transmitted from the computer PC2 to the computer PC1

TABLE 3

| | Destination | Originating | Destination | Originating |
|---|---|---|---|---|
| Process | MAC | MAC | IP | IP |
| (9) | Ma2 | Ma1 | IP2 (Pr) | IP1 (Pr) |
| (10) | Ma1 | Ma2 | IP1 (Pr) | IP2 (Pr) |

While the above embodiment has been described assuming that the destination MAC address and the originating or transmitting source MAC address are not rewritten in the cable modem 16, if a specific MAC address is given to the cable modem 16 and the destination MAC address and the originating MAC address are rewritten there, a destination MAC address given to an Ethernet frame to be transmitted from the router 46 to the outside of the subscriber's premises 12 is used as an MAC address of the cable modem 16 instead of the MAC address “MaC” of the center 10. In addition, while the above embodiment has been described when using a network interface in the side of the LAN port 20 of the cable modem 16 as an Ethernet interface, the present invention is also applicable to an arrangement using any of other network interfaces. Furthermore, while the above embodiment has been described for an arrangement using a network device according to the present invention as a router, it can be configured as a device other than a router.

What is claimed is:

1. A device connectable to a network for use in directing data, comprising:
an interface that is provided for interfacing with the network, and that is allocated with a plurality of physical addresses registered for physically discriminating from other devices; and
a processor that executes a receiving process and a transmitting process of data through the interface, wherein
the receiving process comprises the steps of:
receiving data having a physical address indicating a destination of the data;
comparing the physical address of the received data with the registered physical addresses;
completing the receiving process when the physical address of the received data matches with one of the registered physical addresses; and otherwise
canceling the receiving process when the physical address of the received data matches with none of the registered physical addresses, and wherein the transmitting process comprises the steps of:
detecting a destination of data to be transmitted;
selecting one of the registered physical addresses according to the detected destination of the data to be transmitted; and
attaching the selected physical address to the data, thereby indicating an origin of the data.

2. The device according to claim 1, wherein the interface is allocated with a first physical address for use in an Internet domain, and a second physical address for use in a local area network domain, and wherein
the processor executes the transmitting process such that the selecting step selects the first physical address when the destination of the data to be transmitted is given as a global IP address, and otherwise selects the second physical address when the destination of the data to be transmitted is given as a private IP address.

3. The device according to claim 2, functioning as a DHCP client in the Internet domain so that the DHCP client is allocated a global IP address from another DHCP server of the Internet domain, and also functioning as a DHCP server in the local area network domain so that the DHCP server allocates a private IP address to another DHCP client in the local area network domain, wherein
the processor uses the first physical address for exchanging data with said another DHCP server of the Internet domain, and uses the second physical address for exchanging data with said another DHCP client of the local area network domain.

4. A network device comprising a port connectable to a network, a storage section that stores a plurality of physical addresses registered for physically discriminating from other network devices, a receiver section that executes a receiving process of data inputted from the network through the port, a transmitter section that executes a transmitting process of data outputted to the network through the port, and a controller section that controls the receiver section and the transmitter section, wherein
the receiver section operates when receiving data containing a destination physical address indicating a destination of the data for comparing the destination physical address with the stored physical addresses, thereby completing the receiving process when the destination physical address matches with one of the stored physical addresses, and otherwise for canceling the receiving process when the destination physical address matches with none of the stored physical addresses, and wherein
the transmitter section operates when transmitting data to a desired destination for attaching one of the stored physical addresses, which indicates an origin of the dada and which is designated by the controller section dependently on the desired destination of the dada to be transmitted.

5. The network device according to claim 4, wherein the storage section stores a first physical address for use in an Internet domain, and a second physical address for use in a local area network domain, and wherein
the controller section designates the first physical address when the destination of the data to be transmitted is given as a global IP address, and otherwise designates the second physical address when the destination of the data to be transmitted is given as a private IP address.

6. The network device according to claim 5, functioning as a DHCP client in the Internet domain so that the DHCP client is allocated a global IP address from another DHCP server of the Internet domain, and also functioning as a DHCP server in the local area network domain so that the DHCP server allocates a private IP address to another DHCP client in the local area network domain, wherein
the controller section designates the first physical address for transmitting data to said another DHCP server of the Internet domain, and designates the second physical address for transmitting data to said another DHCP client of the local area network domain.

7. A network device for use in directing data and being connectable to a cable modem having a CATV port and a LAN port, the network device comprising:
a network interface that is connected to the LAN port of the cable modem, and that is allocated with a first physical address selectively used for communication with an outside network interface linked to the CATV port of the cable modem and a second physical address selectively used for communication with an inside network interface linked to the LAN port of the cable modem; and
a processor that executes a receiving process and a transmitting process of data through the network interface, wherein
the receiving process comprises the steps of:
receiving data having a destination physical address indicating a destination of the data;
detecting when the destination physical address of the received data matches with the first physical address for admitting and treating the received data as being transmitted from an outside network interface linked to the CATV port of the cable modem;
detecting when the destination physical address of the received data matches with the second physical address for admitting and treating the received data as being transmitted from an inside network interface linked to the LAN port of the cable modem; and
detecting when the destination physical address of the received data matches with neither of the first physical address and the second physical address for discarding the received data, and wherein
the transmitting process comprises the steps of:
detecting when a destination of data to be transmitted is an outside network interface linked to the CATV port of the cable modem for selecting and attaching the first physical address to the data as an origination physical address indicating an origin of the data; and
detecting when a destination of data to be transmitted is an inside network interface linked to the LAN port of the cable modem for selecting and attaching the second physical address to the data as an origination physical address indicating an origin of the data.

8. The network device according to claim 7, wherein the processor executes the receiving process and the transmitting process by the steps of:
receiving data from an inside network interface linked to the LAN port of the cable modem, the data containing a logical address indicating an ultimate destination of the data;
detecting when the logical address indicates the ultimate destination other than inside network interfaces for rewriting a destination physical address contained in the data to another destination physical address allocated to a predetermined outside network interface and for rewriting an origination physical address contained in the data to the first physical address; and
transmitting the data containing the logical address and the rewritten destination physical address and the rewritten origination physical address, and
wherein processor executes the receiving process and the transmitting process by the steps of:
receiving data from an outside network interface linked to the CATV port of the cable modem, the data containing a logical address indicating an ultimate destination of the data;
detecting when the logical address is allocated to an inside network interface for rewriting a destination physical address contained in the data to another destination physical address allocated to the inside network interface corresponding to the logical address and for rewriting an origination physical address contained in the data to the second physical address; and
transmitting the data containing the logical address and the rewritten destination physical address and the rewritten origination physical address.

9. The network device according to claim 8, wherein the processor executes the transmitting process such that the detecting step detects when the logical address contained in the data represents a global IP address for rewriting a destination physical address to another destination physical address allocated to a CATV center and for rewriting an origination physical address contained in the data to the first physical address, and otherwise detects when the logical address represents a private IP address allocated to an inside network interface for rewriting a destination physical address contained in the data to another destination physical address allocated to the inside network interface corresponding to the private IP address and for rewriting an origination physical address contained in the data to the second physical address.

10. The network device according to claim 9, functioning as a DHCP client in an Internet domain so that the DHCP client is allocated a global IP address from another DHCP server of the CATV center, and also functioning as a DHCP server in a local area network domain so that the DHCP server allocates a private IP address to an inside network interface linked to the LAN port of the cable modem, wherein
the processor uses the first physical address for exchanging data with the CATV center, and uses the second physical address for exchanging data with the inside network interface.

11. A computer network system composed of a plurality of node devices including a device connectable to a network for use in directing data, the device comprising:
an interface that is provided for interfacing with the network, and that is allocated with a first physical address for use in an Internet domain, and a second physical address for use in a local area network domain so as to physically discriminate the device from other node devices; and
a processor that executes a receiving process and a transmitting process of data through the interface, wherein
the receiving process comprises the steps of:
receiving data having a physical address indicating a destination of the data;
comparing the physical address of the received data with the first and second physical addresses;
completing the receiving process when the physical address of the received data matches with either of the first and second physical addresses; and otherwise
canceling the receiving process when the physical address of the received data matches with neither of the first and second physical addresses, and wherein
the transmitting process comprises the steps of:
detecting a destination of data to be transmitted;
selecting the first physical address when the destination of the data to be transmitted is given as a global IP address and otherwise selecting the second physical address when the destination of the data to be transmitted is given as a private IP address which indicates another node device involved in the computer network system; and
attaching the selected physical address to the data, thereby indicating an origin of the data.

12. A computer network system composed of a plurality of node devices including a network device comprising a port connectable to a network, a storage section that stores a first physical address for use in an Internet domain, and a second physical address for use in a local area network domain so as to physically discriminate the network device from other node devices, a receiver section that executes a receiving process of data inputted from the network through the port, a transmitter section that executes a transmitting process of data outputted to the network through the port, and a controller section that controls the receiver section and the transmitter section, wherein
the receiver section operates when receiving data containing a destination physical address indicating a destination of the data for comparing the destination physical address with the first and second physical addresses, thereby completing the receiving process when the destination physical address matches with either of the first and second physical addresses, and otherwise for canceling the receiving process when the destination physical address matches with neither of the first and second physical addresses, wherein
the transmitter section operates when transmitting data to a desired destination for attaching one of the first and second physical addresses, which indicates an origin of the dada and which is designated by the controller section, and wherein
the controller section designates the first physical address when the desired destination of the data to be transmitted is given as a global IP address, and otherwise designates the second physical address when the designated destination of the data to be transmitted is given as a private IP address which indicates another node device involved in the computer network system.

13. A computer network system comprising a cable modem having a CATV port and a LAN port, and a plurality of internal devices being connectable to the LAN port of the cable modem, the system including a network device for use in directing data, wherein the network device comprising:
a network interface that is connected to the LAN port of the cable modem, and that is allocated with a first physical address selectively used for communication with an external device linked to the CATV port of the cable modem and a second physical address selectively used for communication with an internal device linked to the LAN port of the cable modem; and
a processor that executes a receiving process and a transmitting process of data through the network interface, wherein
the receiving process comprises the steps of:
receiving data having a destination physical address indicating a destination of the data;
detecting when the destination physical address of the received data matches with the first physical address for admitting and treating the received data as being transmitted from an external device linked to the CATV port of the cable modem;
detecting when the destination physical address of the received data matches with the second physical address for admitting and treating the received data as being transmitted from an internal device linked to the LAN port of the cable modem; and
detecting when the destination physical address of the received data matches with neither of the first physical address and the second physical address for discarding the received data, and wherein
the transmitting process comprises the steps of:
detecting when a destination of data to be transmitted is an external device linked to the CATV port of the cable modem for selecting and attaching the first physical address to the data as an origination physical address indicating an origin of the data; and
detecting when a destination of data to be transmitted is an internal device linked to the LAN port of the cable modem for selecting and attaching the second physical address to the data as an origination physical address indicating an origin of the data.

14. A method of directing data in a network by use of an interface that is provided for interfacing with the network and that is allocated with a plurality of physical addresses registered for physically discriminating from other devices, the method executing a receiving process and a transmitting process of data through the interface, wherein
the receiving process comprises the steps of:
receiving data having a physical address indicating a destination of the data;
comparing the physical address of the received data with the registered physical addresses;
completing the receiving process when the physical address of the received data matches with one of the registered physical addresses; and otherwise
canceling the receiving process when the physical address of the received data matches with none of the registered physical addresses, and wherein
the transmitting process comprises the steps of:
detecting a destination of data to be transmitted;
selecting one of the registered physical addresses according to the detected destination of the data to be transmitted; and
attaching the selected physical address to the data, thereby indicating an origin of the data.

15. A method of operating a network device having a port connectable to a network, a storage that stores a plurality of physical addresses registered for physically discriminating from other network devices, a receiver that executes a receiving process of data inputted from the network through the port, a transmitter that executes a transmitting process of data outputted to the network through the port, and a controller that controls the receiver and the transmitter, the method comprising the steps of:
operating the receiver when receiving data containing a destination physical address indicating a destination of the data for comparing the destination physical address with the stored physical addresses, thereby completing the receiving process when the destination physical address matches with one of the stored physical addresses, and otherwise canceling the receiving process when the destination physical address matches with none of the stored physical addresses; and
operating the transmitter when transmitting data to a desired destination for attaching one of the stored physical addresses, which indicates an origin of the dada and which is designated by the controller dependently on the desired destination of the dada to be transmitted.

16. A method of directing data through a network by means of a network device being connectable to a cable modem having a CATV port and a LAN port, the network device having a network interface that is connected to the LAN port of the cable modem and that is allocated with a first physical address selectively used for communication with an outside network interface linked to the CATV port of the cable modem and a second physical address selectively used for communication with an inside network interface linked to the LAN port of the cable modem, the method executing a receiving process and a transmitting process of data through the network interface, wherein
the receiving process comprises the steps of:
receiving data having a destination physical address indicating a destination of the data;
detecting when the destination physical address of the received data matches with the first physical address for admitting and treating the received data as being transmitted from an outside network interface linked to the CATV port of the cable modem;
detecting when the destination physical address of the received data matches with the second physical address for admitting and treating the received data as being transmitted from an inside network interface linked to the LAN port of the cable modem; and
detecting when the destination physical address of the received data matches with neither of the first physical address and the second physical address for discarding the received data, and wherein
the transmitting process comprises the steps of:
detecting when a destination of data to be transmitted is an outside network interface linked to the CATV port of the cable modem for selecting and attaching the first physical address to the data as an origination physical address indicating an origin of the data; and
detecting when a destination of data to be transmitted is an inside network interface linked to the LAN port of the cable modem for selecting and attaching the second physical address to the data as an origination physical address indicating an origin of the data.

17. A machine readable medium for use in an interface having a CPU for directing data in a network through the interface that is provided for interfacing with the network and that is allocated with a plurality of physical addresses registered for physically discriminating from other devices, the medium containing program instructions executable by the CPU to perform a receiving process and a transmitting process of data through the interface, wherein
the receiving process comprises the steps of:
receiving data having a physical address indicating a destination of the data;
comparing the physical address of the received data with the registered physical addresses;
completing the receiving process when the physical address of the received data matches with one of the registered physical addresses; and otherwise
canceling the receiving process when the physical address of the received data matches with none of the registered physical addresses, and wherein
the transmitting process comprises the steps of:
detecting a destination of data to be transmitted;
selecting one of the registered physical addresses according to the detected destination of the data to be transmitted; and
attaching the selected physical address to the data, thereby indicating an origin of the data.

18. A machine readable medium for use in a network device having a port connectable to a network, a storage that stores a plurality of physical addresses registered for physically discriminating from other network devices, a receiver that performs a receiving process of data inputted from the network through the port, a transmitter that performs a transmitting process of data outputted to the network through the port, and a processor that controls the receiver and the transmitter, the medium containing program instructions executable by the processor for causing the network device to perform a method comprising the steps of:
controlling the receiver when receiving data containing a destination physical address indicating a destination of the data for comparing the destination physical address with the stored physical addresses, thereby completing the receiving process when the destination physical address matches with one of the stored physical addresses, and otherwise canceling the receiving process when the destination physical address matches with none of the stored physical addresses; and
controlling the transmitter when transmitting data to a desired destination for attaching one of the stored physical addresses, which indicates an origin of the dada and which is designated by the processor dependently on the desired destination of the dada to be transmitted.

19. A machine readable medium for use in a network device having a CPU for directing data through a network by the network device being connectable to a cable modem having a CATV port and a LAN port, the network device having a network interface that is connected to the LAN port of the cable modem and that is allocated with a first physical address selectively used for communication with an outside network interface linked to the CATV port of the cable modem and a second physical address selectively used for communication with an inside network interface linked to the LAN port of the cable modem, the medium containing program instructions executable by the CPU for causing the network device to perform a receiving process and a transmitting process of data through the network interface, wherein
the receiving process comprises the steps of:
receiving data having a destination physical address indicating a destination of the data;
detecting when the destination physical address of the received data matches with the first physical address for admitting and treating the received data as being transmitted from an outside network interface linked to the CATV port of the cable modem;
detecting when the destination physical address of the received data matches with the second physical address for admitting and treating the received data as being transmitted from an inside network interface linked to the LAN port of the cable modem; and
detecting when the destination physical address of the received data matches with neither of the first physical address and the second physical address for discarding the received data, and wherein
the transmitting process comprises the steps of:
detecting when a destination of data to be transmitted is an outside network interface linked to the CATV port of the cable modem for selecting and attaching the first physical address to the data as an origination physical address indicating an origin of the data; and
detecting when a destination of data to be transmitted is an inside network interface linked to the LAN port of the cable modem for selecting and attaching the second physical address to the data as an origination physical address indicating an origin of the data.

20. A device connectable to a network for use in directing data, comprising:
interface means for interfacing with the network, the interface means being allocated with a plurality of physical addresses registered for physically discriminating from other devices; and
processor means including receiving means for executing a receiving process of data through the interface means and transmitting means for executing a transmitting process of data through the interface means, wherein
the receiving means comprises means for receiving data having a physical address indicating a destination of the data, means for comparing the physical address of the received data with the registered physical addresses, means for completing the receiving process when the physical address of the received data matches with one of the registered physical addresses, and means for canceling the receiving process when the physical address of the received data matches with none of the registered physical addresses, and wherein
the transmitting means comprises means for detecting a destination of data to be transmitted, means for selecting one of the registered physical addresses according to the detected destination of the data to be transmitted, and means for attaching the selected physical address to the data, thereby indicating an origin of the data.

21. A network device comprising port means connectable to a network, storage means for storing a plurality of physical addresses registered for physically discriminating from other network devices, receiver means for executing a receiving process of data inputted from the network through the port means, transmitter means for executing a transmitting process of data outputted to the network through the port means, and controller means for controlling the receiver means and the transmitter means, wherein
the receiver means operates when receiving data containing a destination physical address indicating a destination of the data for comparing the destination physical address with the stored physical addresses, thereby completing the receiving process when the destination physical address matches with one of the stored physical addresses, and otherwise for canceling the receiving process when the destination physical address matches with none of the stored physical addresses, and wherein
the transmitter means operates when transmitting data to a desired destination for attaching one of the stored physical addresses, which indicates an origin of the dada and which is designated by the controller means dependently on the desired destination of the dada to be transmitted.

22. A network device for use in directing data and being connectable to a cable modem having a CATV port and a LAN port, the network device comprising:
network interface means being connected to the LAN port of the cable modem, and being allocated with a first physical address selectively used for communication with an outside network interface linked to the CATV port of the cable modem and a second physical address selectively used for communication with an inside network interface linked to the LAN port of the cable modem; and
processor means including receiving means for executing a receiving process of data through the network interface means and transmitting means for transmitting process of data through the network interface means, wherein
the receiving means comprises:
means for receiving data having a destination physical address indicating a destination of the data;
means for detecting when the destination physical address of the received data matches with the first physical address for admitting and treating the received data as being transmitted from an outside network interface linked to the CATV port of the cable modem;
means for detecting when the destination physical address of the received data matches with the second physical address for admitting and treating the received data as being transmitted from an inside network interface linked to the LAN port of the cable modem; and
means for detecting when the destination physical address of the received data matches with neither of the first physical address and the second physical address for discarding the received data, and wherein
the transmitting means comprises:
means for detecting when a destination of data to be transmitted is an outside network interface linked to the CATV port of the cable modem for selecting and attaching the first physical address to the data as an origination physical address indicating an origin of the data; and
means for detecting when a destination of data to be transmitted is an inside network interface linked to the LAN port of the cable modem for selecting and attaching the second physical address to the data as an origination physical address indicating an origin of the data.
